(19) United States
(12) Patent Application Publication
(10) Pub. No.: US 2025/0252480 A1
(43) Pub. Date: Aug. 7, 2025

(54) SYSTEM AND METHOD FOR LOCATING IN-STORE PRODUCTS

(71) Applicant: Jacob Kaufman, West Bloomfield, MI (US)

(72) Inventor: Jacob Kaufman, West Bloomfield, MI (US)

(21) Appl. No.: 19/187,097

(22) Filed: Apr. 23, 2025

Related U.S. Application Data
(63) Continuation of application No. 17/961,512, filed on Oct. 6, 2022, now Pat. No. 12,307,502.
Application No. 17/961,512 is a continuation of application No. 16/867,366, filed on May 5, 2020, now Pat. No. 11,481,831.
Application No. 16/867,366 is a continuation of application No. 15/680,630, filed on Aug. 18, 2017, now Pat. No. 10,679,275.
(60) Provisional application No. 62/376,999, filed on Aug. 19, 2016.

(51) Int. Cl. G06Q 30/0601; G06K 7/14

(52) U.S. Cl. CPC G06Q 30/0633; G06K 7/1413; G06Q 30/0623

(57) ABSTRACT

A mobile application (“app”) enabling a shopper to identify an item or items that the user wishes to locate or purchase. The device displays a list of stores which stock the item(s), and a user is then provided with in-store guidance enabling the shopper to find the item or items that the user wishes to locate or purchase. A user can identify an item or items by scanning a product bar code, scanning a product label; capturing an image of a product, or typing a product name in a search field. The method further includes identifying stores that stock the item. Items can be added to an accumulative shopping list, and items may be ordered online if not available nearby. The system provides basic navigation to store(s) carrying the item(s). Once at a store, an interior route to a product is portrayed through an overhead view map of a store layout. Once near a product, a user may be shown a virtual display of a shelf with the vertical or height placement of the product on the nearby shelf.

### REFERENCE TO RELATED APPLICATIONS

This Application is a continuation of U.S. patent application Ser. No. 16/867,366, filed May 5, 2020, now U.S. Pat. No. 11,481,831, which is a continuation of U.S. patent application Ser. No. 15/680,630, filed Aug. 18, 2017, now U.S. Pat. No. 10,679,275, which claims priority to, and the benefit of, U.S. Provisional Patent Application Ser. No. 62/376,999, filed Aug. 19, 2016, the entire content of all Related Applications being incorporated herein by reference.

### FIELD OF THE INVENTION

This invention resides in a mobile application that directs customers to a specific shelf location to find a desired item without the need for 3D scanning or geo-locating technologies.

### BACKGROUND OF THE INVENTION

Unfortunately shopping can be a frustrating, unpleasant experience. Due to the plethora of competing products and the number of stores which might carry them, finding the right store(s) at the right price(s) can be challenging.

The current industry standard for retail stores is to place items based on bar-code UPC label on a shelf location, which also has a bar-code UPC label. For standard inventory tracking, each item is associated with a specific shelf placement. However, this system does not provide consumers with direct assistance, who just want to find what they are looking for.

Clearly any device or method that can assist shoppers would be of benefit to consumers.

### SUMMARY OF THE INVENTION

This invention assists shoppers by providing a device and method of locating in-store products. The preferred embodiment resides in a portable electronic device with application software enabling a user to identify an item or items that the user wishes to locate or purchase. The device displays a list of stores which stock the item(s), and a user is then provided with in-store guidance enabling the shopper to find the item or items that the user wishes to locate or purchase.

A user can identify an item or items by scanning a product bar code, scanning a product label; capturing an image of a product, or typing a product name in a search field. The method further includes identifying stores that stock the item. Items can be added to an accumulative shopping list, and items may be ordered online if not available nearby.

The system provides basic navigation to store(s) carrying the item(s). Once at a store, an interior route to a product is portrayed through an overhead view map of a store layout. Once near a product, a user may be shown a virtual display of a shelf with the vertical or height placement of the product on the nearby shelf. If the customer has created a shopping list of items, the customer may be directed to the next nearest item on the list.

A store's layout may be created with 3D software once a store has created an online account, with the system and method further including the step of synchronizing the store's inventory with the online account for tracking of shelf placement locations.

### BRIEF DESCRIPTION OF THE DRAWINGS

FIG. 1 depicts the options available to a user for searching goods;

FIG. 2 illustrates a typical scanning process;

FIG. 3 depicts the results of a search;

FIG. 4 shows how the application also provides best picks/sorting based upon various criteria, such as proximity, price, sales, discounts, etc.;

FIG. 5 illustrates how, once at the store, the interior route to a product is displayed via overhead view map of store layout;

FIG. 6 depicts how, once near a product, the customer will be shown a virtual display of the shelf with the vertical or height placement of the product on the nearby shelf; and

FIG. 7 shows how, once the customer has created a shopping list of items, they are directed to the next nearest item on the list.

### DETAILED DESCRIPTION OF THE PREFERRED EMBODIMENTS

This invention resides in a mobile application that directs customers to a specific shelf location to find a desired item without the need for 3D scanning or geo-locating technologies. The solution integrates a retail location's existing shelving placement inventory system with an overall layout of the store's floor plan. The system and method, referred to herein as “StoreTrek,” follows a device user within this layout and directs customers to a specific shelf location to find an item. This process is accomplished without any need for iBeacons, 3D scanning, or GPS technologies. Once a store layout is configured with a store manager, the software synchronizes with the layout database and coordinates with a hand-held device location to report product locations to the users.

The invention is preferably implemented as a software application (“app”) used by customers to find products within a store via a virtual map of a store's interior. This is carried out by both encompassing an overhead overall layout as well as a horizontal shelf-by-shelf layout to vertically locate products within a particular height of a shelf placement.

StoreTrek is also used by store managers and/or stock managers to place and track inventory on shelves. Stores can use the software to place products within a specific grid vertically and horizontally on a virtual version of their store shelves.

The invention accomplishes these processes by utilizing the store's existing bar code stock systems and creating a virtual 3D layout version of the entire store that can be edited by store managers, even if shelves are moved or re-arranged at any time.

StoreTrek is to be offered to customers for free with advertisements included in the interface. Advertisements will offset the cost of development and operating expenses. A paid “pro” version will be offered for those customers who do not want to be bothered by advertisements. It is anticipated that store manager versions of the StoreTrek system will be “pro” versions and are included with a store's subscription account to the StoreTrek service and part of creating their virtual store account and inventory system.

There are three primary functions implemented by the StoreTrek system. First, a user identifies an item or items they wish to locate/purchase. Second, stores are presented that stock the identified item(s), and third, the user is provided in-store guidance to find the actual item or items they are looking for. Each one of these functions includes sub-functions to streamline the process overall.

For example, after opening the StoreTrek app, a user can search for products by:
Scanning the product bar code;
Scanning the product label;
Scanning the entire product itself; or
Typing the product name in a search field.

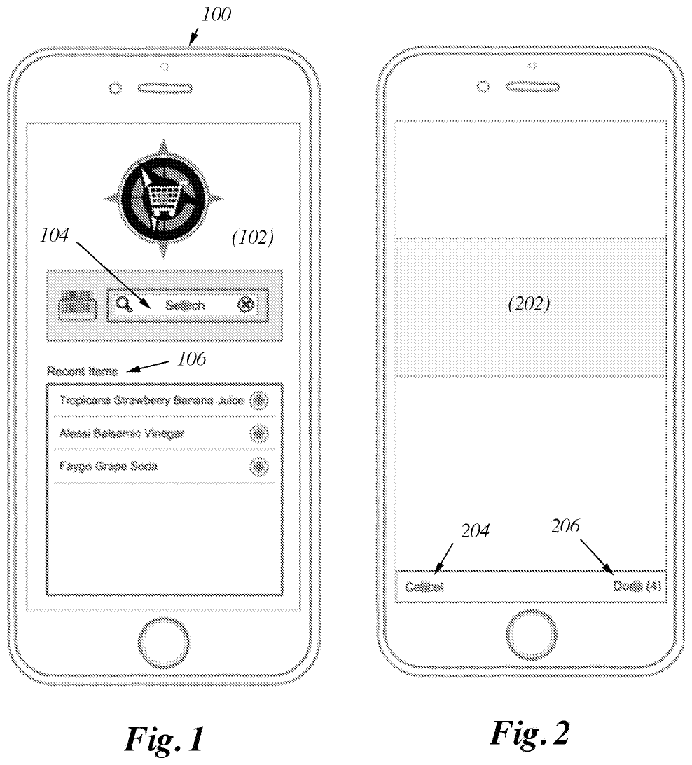

FIG. 1 illustrates these options. Opening the application initiates three primary actions: (1) Launching of the device scanner and camera verified with windows such as window 102 for the scanner; (2) Providing a search field 104; and (3) Showing a listing of Recent Items enabling a user to replace items with new ones. Selecting a PLUS icon automatically adds the newly identified product to the list. Regardless of the search approach used, it is anticipated that a search will be conducted via an Internet connection prompted by the app to match the user input with a specific product. For example, if a product name is entered incorrectly in the search field, corrected results will be presented for clarification.

FIG. 2 illustrates a typical scanning process. Area 202 shows the scanning process, with touch areas 204, 206 being used for DONE and CANCEL functions, respectively. Note that the label and products scans are nearly identical, except that area 202 shows the product or label being captured. Results of the search are shown as follows:
Nearby stores with product are shown
Products can be added to an accumulative shopping list
Ordered online if not available nearby

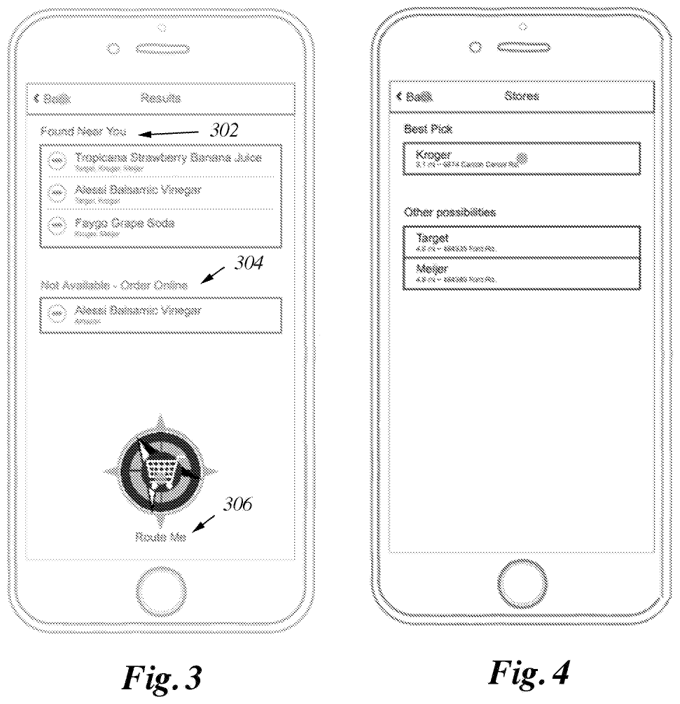

FIG. 3 depicts the results of search. As can be seen, the app found various locations where three items 302 may be purchased, as well as an on-line option for an item 304 that could not be located nearby. After items are added to the Results list, the app automatically determines which nearby stores have the items in-stock. A Route Me action 306 acts upon the items in the Results list. Items not available are offered suggestions to affiliate locations such as Amazon (allowing further monetization).

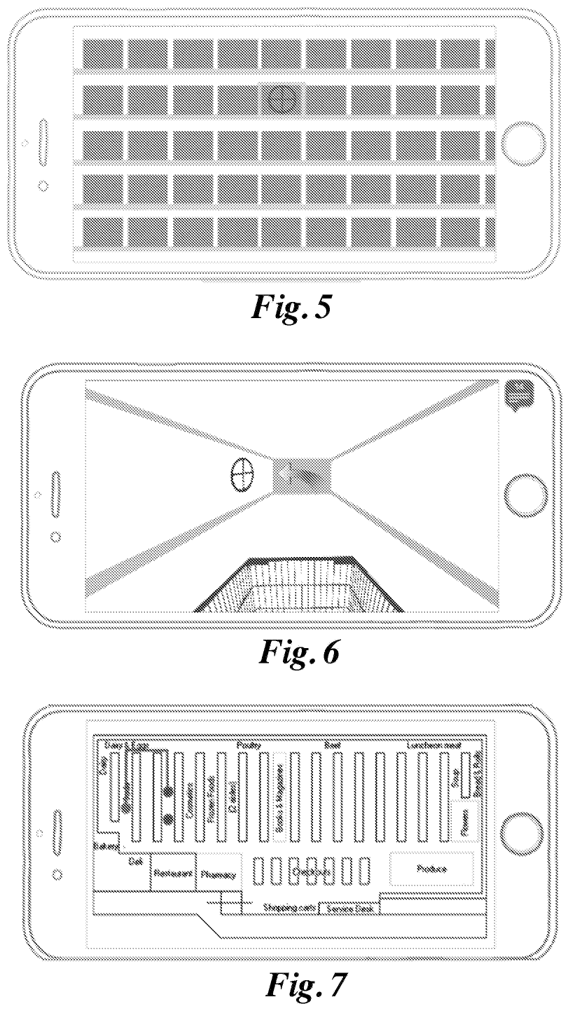

As shown in FIG. 4, the app will also provide best picks/sorting based upon various criteria, such as proximity, price, sales, discounts, etc., enabling a user to select a desired store. As part of a purchasing decision, if a user selects “Route Me,” various actions will be taken:
Basic navigation to the store is an option available.
Once at the store, the interior route to a product is show via overhead view map of store layout (FIG. 5);
Once near a product the customer will be shown a virtual display (FIG. 6) of the shelf with the vertical or height placement of the product on the nearby shelf; and.
If the customer has created a shopping list of items, they are then directed to the next nearest item on the list (FIG. 7).

### Store Manager Experience

A store's layout is created with 3D software once a store has created their online account and their inventory system is synchronized with this account for tracking of shelf placement locations.
Store managers orientate shelving units, end-cap shelves and various furniture objects to the proper orientation of their location in the real store.
All shelving units have grid sizes that are adjustable for various size product placements and can be edited for number of vertical shelves, horizontal length, vertical height and display angles.
All shelving grid placement areas are barcode specific and database registered with a store's account so they can be assigned a product
Store managers scan products into inventory as they normally would and subsequently scan a shelves bar code area for its placement-meanwhile, their StoreTrek account database is updated to synchronize the product placement into inventory with the shelf's placement.
Store managers can use the StoreTrek app via a mobile device to scan products into inventory or they can use their existing bar code inventory scanners. As an added benefit of using StoreTrek, our app will update to show them the product placement on the virtual shelf whereas their existing system will not.
Store managers can edit their layout, shelf placement and furniture displays at any time in the online account.
StoreTrek online account subscriptions can be fully integrated into a retailer's online presence, website and online store.
Product delivery services can easily take advantage of StoreTrek and retailers can integrate shopping services experiences for the “stay-at-home” shopper to shop for products virtually and then have everything delivered to their home.

Other options include mobile device location tracking within the store interior as well as integration with a store's wireless system for instant sales, marketing and other various retail applications. Ultimately the StoreTrek app will provide a full augmented-reality shopping experience while also benefiting stores with a state-of-the art inventory shelf placement tracking system that is both easy to use and can be utilized from any mobile device.

1-19. (canceled)

20. A system for locating in-store products, the system comprising:
a software application that creates an account for one or more subscriber stores, wherein for each created account includes a virtual three-dimensional graphical layout of a corresponding subscriber store including an overhead view map and a vertical or height placement view for a product is generated;
a portable electronic device including a display, the portable electronic device executing a software application to:
(a) receive a search query for a product of interest that a user wishes to locate or purchase in-store;
(b) in response to tracking the portable electronic device at a selected nearby subscriber store, display, via the display, an interior route to the product of interest via the overhead view map; and
(c) in response to tracking the portable electronic device near the product of interest, display, via the display, a graphical representation of the product's location in the three-dimensional graphical layout of the store, the representation including a shelf indicator showing the vertical or height placement of the product of interest, thereby enabling the user to locate the product within the store using the overhead view map and the vertical or height placement information.

21. The system of claim 20, wherein the portable electronic device further executes the software application to:
track the location of the portable electronic device.

22. The system of claim 20, further comprising a database storing subscriber store accounts and corresponding product inventory data, the product inventory data including a layout with product placement locations, wherein the software application synchronizes with the database and coordinates with the portable electronic device to report product locations to the user.

23. The system of claim 20, wherein the three-dimensional layout includes shelves with grids for product placement.

24. The system of claim 20, wherein the search query includes at least one of a product name, a scanned product barcode, a scanned product label, or an image of the product.

25. The system of claim 20, wherein the portable electronic device is a smartphone or tablet.

26. The system of claim 20, wherein the software application enables the user to generate a shopping list of different products of interest.

27. The system of claim 20, wherein the three-dimensional graphical layout of the corresponding subscriber store includes a plurality of shelves that show a vertical or height placement of products on the shelves.

28. A method for locating in-store products, the method comprising:
creating, via a software application, an account for one or more subscriber stores;
generating, for each created account, a virtual three-dimensional graphical layout of a corresponding subscriber store, the layout including an overhead view map and a vertical or height placement view for a product;
tracking the location of a portable electronic device;
executing, on the portable electronic device, a software application to:
receive a search query for a product of interest that a user wishes to locate or purchase in-store;
in response to tracking the portable electronic device at a selected nearby subscriber store, display, via the display, an interior route to the product of interest via the overhead view map; and
in response to tracking the portable electronic device near the product of interest, display, via the display, a location of the product of interest in or on the three-dimensional graphical layout of the store via a graphical representation of a shelf showing the vertical or height placement of the product of interest on the shelf, thereby enabling the user to locate the product within the store using the overhead view map and the vertical or height placement of the scanned products within the store.

29. The method of claim 28, further comprising:
storing, in a database, subscriber store accounts and corresponding product inventory data, the product inventory data including a layout with product placement locations;
synchronizing, via the software application, with the database and coordinating with the portable electronic device to report product locations to the user.

30. The method of claim 28, wherein the portable electronic device includes a camera and a user input.

31. The method of claim 28, wherein the search query includes at least one of a product name, scanned product barcode, a scanned product label, or an image of the product.

32. The method of claim 28, wherein the portable electronic device is a smartphone or tablet.

33. The method of claim 28, further comprising enabling, via the software application, the user to generate a shopping list of different products of interest.

34. The method of claim 28, wherein the three-dimensional graphical layout of the store includes a plurality of shelves that show a vertical or height placement of products on the shelves.

35. The method of claim 28, wherein the three-dimensional graphical layout includes shelves with grids for product placement.

36. A non-transitory computer-readable storage medium storing instructions executable by one or more processors of a computing device, the instructions, when executed, causing the computing device to perform operations comprising:
creating, via a software application, an account for one or more subscriber stores;
generating, for each created account, a virtual three-dimensional graphical layout of a corresponding subscriber store, the layout including an overhead view map and a vertical or height placement view for a product;
tracking the location of a portable electronic device;
executing, on the portable electronic device, a software application to:
receive a search query for a product of interest that a user wishes to locate or purchase in-store;
in response to tracking the portable electronic device at the selected nearby subscriber store, display, via the display, an interior route to the product of interest via the overhead view map; and
in response to tracking the portable electronic device near the product of interest, display, via the display, a location of the product of interest in or on the three-dimensional graphical layout of the store via a graphical representation of a shelf showing the vertical or height placement of the product of interest on the shelf, thereby enabling the user to locate the product within the store using the overhead view map and the vertical or height placement of the scanned products within the store.

37. The non-transitory computer-readable storage medium of claim 36, wherein the instructions, when executed, further cause the computing device to synchronize and coordinate, via the software application, with a database to report product locations to the user, the database including subscriber store accounts and corresponding product inventory data, the product inventory data including a layout with product placement locations.

38. The non-transitory computer-readable storage medium of claim 36, wherein the portable electronic device includes a camera and a user input, and the instructions further cause the computing device to receive a search query including at least one of a product name, a scanned product barcode, a scanned product label, or an image of the product.

39. The non-transitory computer-readable storage medium of claim 36, wherein the three-dimensional graphical layout of the store includes a plurality of shelves that show a vertical or height placement of products on the shelves.
